(19) United States
(12) Patent Application Publication
(10) Pub. No.: US 2008/0167945 A1
(43) Pub. Date: Jul. 10, 2008

(54) Tissue storage and dispenser

(75) Inventor: John Erwin Harrington, Knoxville, TN (US)

Correspondence Address: JOHN E. HARRINGTON, 5706 CRESTWOOD DR., KNOXVILLE, TN, 37914-5112, US

(73) Assignee: JOHN ERWIN HARRINGTON, KNOXVILLE, TN (US)

(21) Appl. No.: 11/704,008

(22) Filed: Feb. 8, 2007

Related U.S. Application Data
(60) Provisional application No. 60/878,964, filed on Jan. 5, 2007.

(51) Int. Cl. G06F 17/30

(52) U.S. Cl. 705/10

(57) ABSTRACT

There are two technical parts of this submission and they are contained in FIGS. #2 & #7, shown as the “SIDES OF THE UNIT” and the “ROLLER COMPRESSION RAMP”.

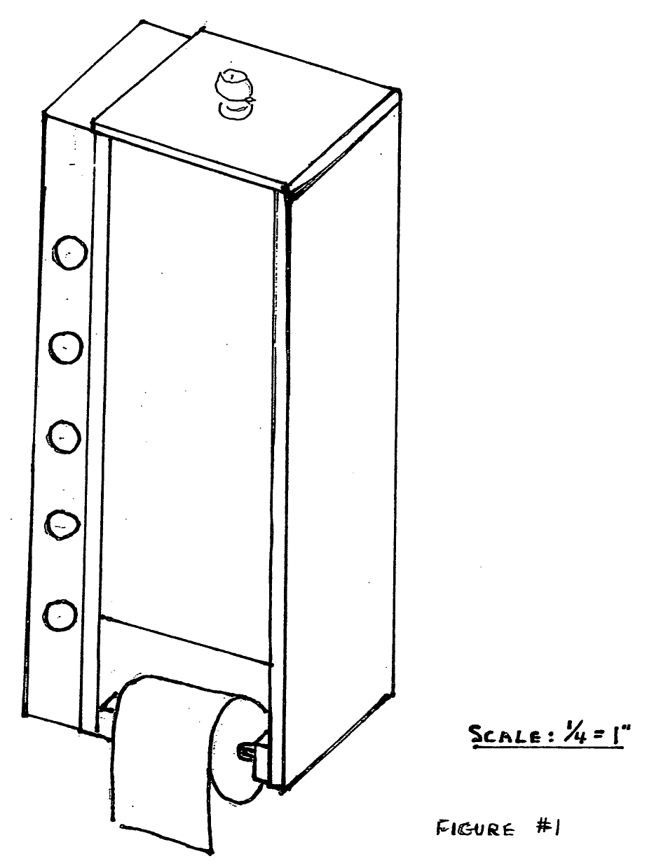

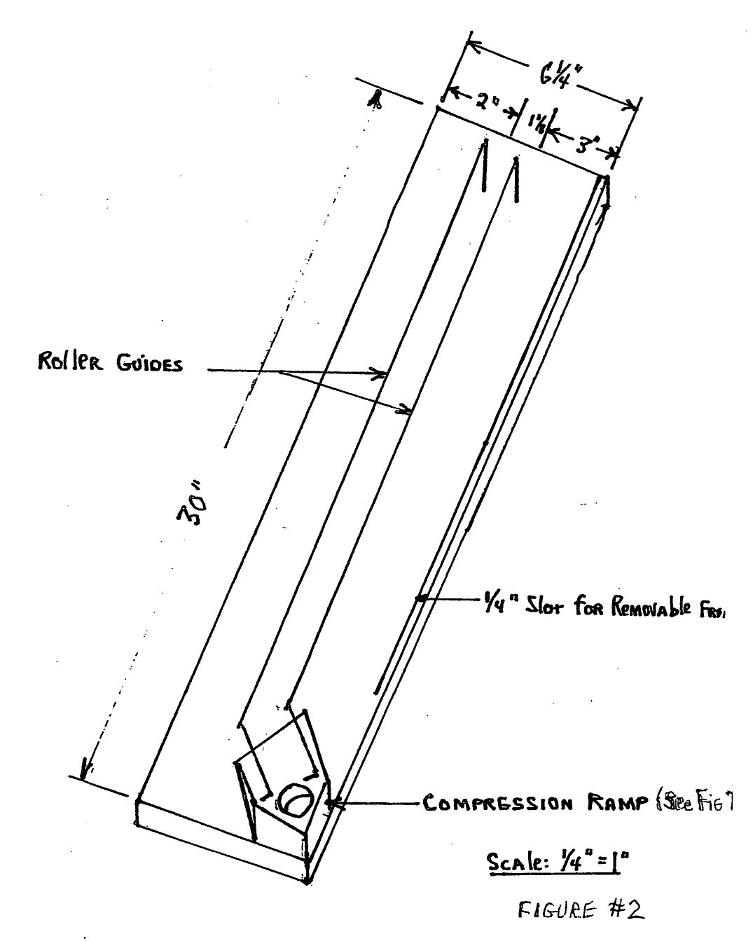

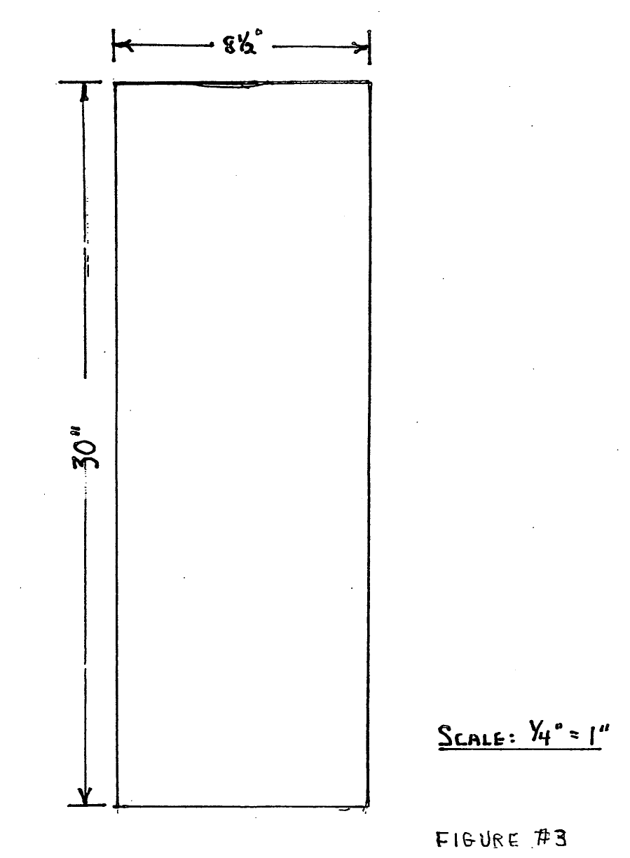

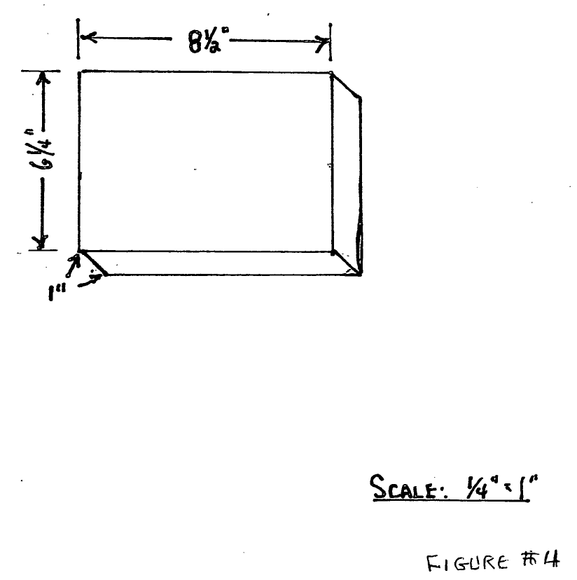

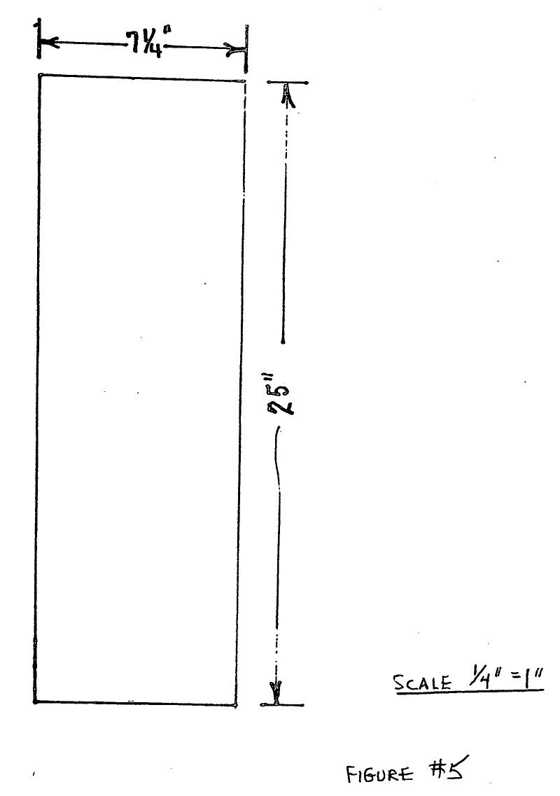

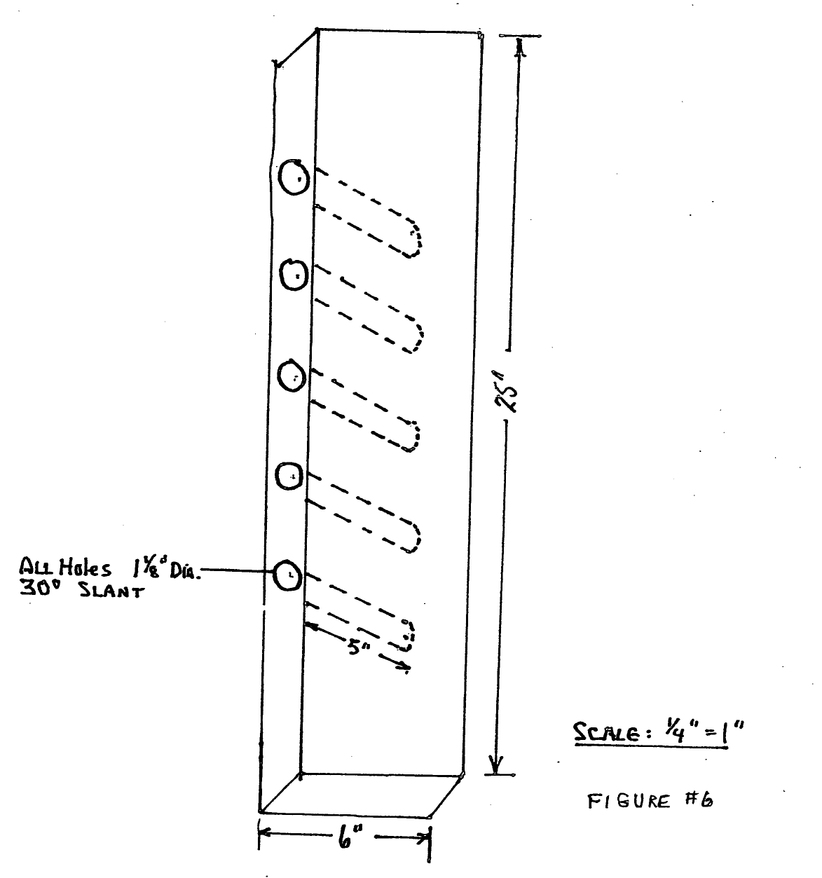

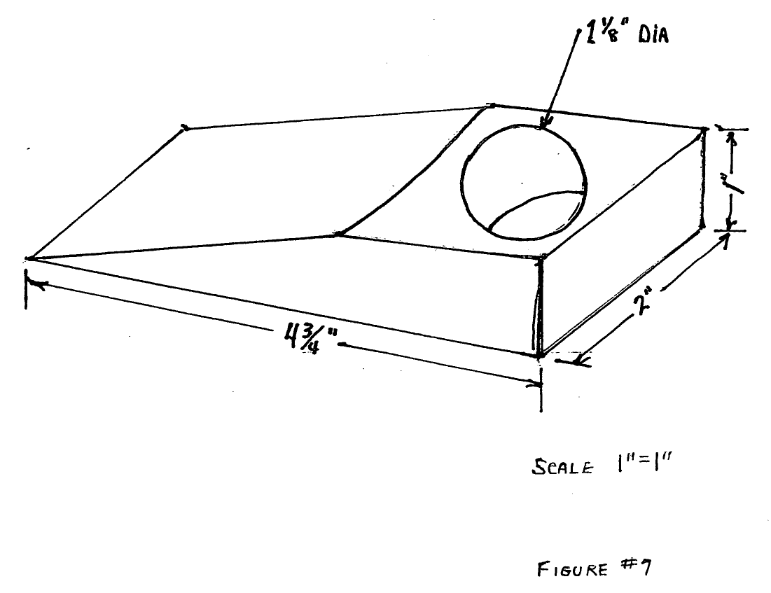

First, the SIDES OF THE UNIT contain “Roller Guides” that are used to guide the Tissue on the Rollers to and up the “ROLLER COMPRESSION RAMP” and finally deposit them into the usable position.

Finally, the ROLLER COMPRESSION RAMPS are used to compress the springs within the rollers and follow the “ROLLER GUIDES” to the usable position.

### CROSS REFERENCE TO RELATED APPLICATIONS

We know of no related applications. A market research only shows the usual single Tissue roll holder, except for commercial use, and there are several such, but none to match the utility of this invention for residential properties.

### STATEMENT REGARDING FEDERALLY SPONSORED RESEARCH OR DEVELOPMENT

The Federal Government has had absolutely nothing to do with this invention.

### BACKGROUND OF THE INVENTION

The invention is dedicated to utility convenience. Frequently we find ourselves in need. No tissue available. Bad enough at home, worse as a guest. This invention will provide tissue at all times, as storage is provided and available.

### BREIF SUMMARY OF THE INVENTION

This invention is to provide a continuing supply of tissue for any user. The idea came about after finding no tissue available. One of lifes embarassing moments. The advantage is obvious, in that there should never be a shortage of tissue for residents or guests. The object of the invention is to provide a six pack of tissue, available to any user without an embarassing moment. At home, this may not be a major problem, however as a guest, where do you turn?

### BRIEF DESCRIPTION OF THE DRAWINGS

Drawings include a three dimention of the complete unit, a drawing of the sides, back, top, roller storage unit and blown up drawing of the loading devise. Invention may be surface mounted or recessed.

### DETAILED DESCRIPTION OF THE INVENTION

This invention may be constructed or molded out of any material, such as wood, plastic, metal or molded products. The dimentions furnished herewith are those to fit the usual market supply of six rolls of tissue. Dimentions may be changed to the desire of the user. There is nothing mechanical about the invention. Again, a market research has been made, and we find nothing to compare. Anyone can make this unit.

### DESCRIPTION OF THE DRAWINGS

FIG. #1 is a three dimentionsl drawing of the completed unit. It is presented in a Scale of ¼ ″=1″. The lid is removable for loading the tissue on roller into the “roller guides”, as shown on FIG. #2. The Front as shown on FIG. #5, is removable and may contain personal messages such as the initials of the homeowner, or Merry Christmas etc.

FIG. #2 is in three dimention, showing the Roller Guides (which may be made of metal or plastic), and the Roller Compression Ramp (See FIG. #7). The rolls of tissue are held between the sides, and move downward as used. They are pulled forward and fall into the holes provided in the compression ramp.

FIG. #3 is a two dimentional drawing on a scale of ¼ ″=1″, of the “BACK OF THE UNIT”. This is simply a one piece back for the unit. It attaches to the rear of the sides shown on FIG. #2. It may be made of wood, plastic or metal. The dimentions may be changed to suit the users needs.

FIG. #4 is three dimentional on a scale of ¼ ″=1″, of the “TOP OF THE UNIT”. It fits onto the top of the unit, and may be made of wood, plastic or metal. It is removed for the purposes of loading additional tissue, on rollers, into the unit.

FIG. #5 is two dimentional on a scale of ¼ ″=1″, of the “FRONT OF THE UNIT”. The dimentions may vary to satisfy the needs of the user, and may be made of wood, plastic or metal. May be fixed or removable and contain the users special messages. (Such as: INITIALS, MERRY CHRISTMAS, EtC.)

FIG. #6 is three dimentional on a Scale of ¼ ″=1″, of the TISSUE ROLLER STORAGE”. This may be attached to either side of the unit, and is used to store the empty rollers until the unit is reloaded. May vary in dimention to suit needs of the user, and may be made of wood, plastic or metal.

FIG. #7 is three dimentional on a scale of 1″=1″, of the “ROLLER COMPRESSION RAMP”. As the rollers follow the “Roller Guides” shown on FIG. #2, they reach this compression unit. The tissue is stopped by this unit until needed as a refill. The roller guides are used to guide and compress the roller and release them into the holes provided so that the tissue is in position for use.

1. After having completing a Market Research, including Lowes, Home Depot and Walmart, we found nothing compares with the utility of this invention for the residential market. In fact, we feel that the market for such is in the 150,000,000 range. I believe that all people have been in those embarassing moments where no tissue was available. This invention should resolve that situation if kept current. The invention may be changed in size to comply with the needs of the user.
